(19) United States
(12) Patent Application Publication
(10) Pub. No.: US 2009/0000206 A1
(43) Pub. Date: Jan. 1, 2009

(54) Weather strip for motor vehicle

(75) Inventors: Teruyuki Okajima, Aichi-ken (JP); Toshifumi Kakami, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Nishikasugai-gun (JP)

(21) Appl. No.: 12/213,988

(22) Filed: Jun. 26, 2008

(30) Foreign Application Priority Data
Jun. 29, 2007 (JP) 2007-172929

(51) Int. Cl. E06B 7/16; E06B 7/22

(52) U.S. Cl. 49/493.1; 49/475.1; 49/498.1

(57) ABSTRACT

A door weather strip which is difficult to come off a door frame and can be readily manufactured. A vertical side member of the door weather strip has an upper vertical member for attachment to an upper part of a vertical side of the door frame, and a lower vertical member for attachment to a lower part of a vertical side of an outer periphery of a door, the upper vertical member and the lower vertical member are joined to each other via a vertical joint member. A base portion of the upper vertical member is retained with a retainer, and the lower vertical member is retained with clips or double-sided adhesive tapes. The vertical joint member has a core drawing slit in a base portion thereof from the position lower than a joint end of the upper vertical member to the position in the vicinity of a joint end of the lower vertical member such that the core drawing slit is not closed by bonding. And one of side end edges of the base portion of the vertical joint member is formed to protrude by a width less than that of the other side end edge thereof.

### CROSS-REFERENCE TO RELATED APPLICATION

This application is related to and claims priority from Japanese patent application No. 2007-172929, incorporated herein by reference.

### BACKGROUND OF THE INVENTION

1. Field of the Invention

The present invention relates to a door weather strip for providing a seal between a vehicle door and a door opening portion of a vehicle body.

2. Description of Related Art

As shown in FIG. 1, a vehicle door is sealed against a door opening portion 10 of a vehicle body with a door weather strip 12 which is attached to an outer periphery of a door frame 14, etc. and/or an opening trim weather strip (not shown) which is attached to a flange projecting from the door opening portion 10. And a door glass 16 is sealed against the door frame 14 with a glass run (not shown) which is attached to a channel provided in an inner periphery of the door frame 14.

And, as shown in FIG. 2, the door weather strip 12 for attachment to the door frame 14 and an outer periphery of a door panel 18 has a base portion 20 and a seal portion which is integrally formed with the base portion 20 on an upper side thereof, and the seal portion includes a tubular seal part 22 and a seal lip 24.

The base portion 20 is fitted in a retainer 26 which is secured to the outer periphery of the door frame 14. The seal lip 24 contacts an exterior edge of the door opening portion 10 to provide a seal between the door opening portion 10 and the door frame 14, and the tubular seal part 22 contacts the door opening portion 10 on the interior side of the contacting position of the seal lip 24 to provide double seals between the door opening portion 10 and the door frame 14.

The door weather strip 12 may have different cross-sectional configurations depending on parts for attachment to the door frame 14 and the door panel 18. Consequently, as shown in FIG. 3, the door weather strip 12 may have molded joint members 28 in the vicinity of joints between the door frame 14 and the door panel 18, and molded corner members 30 in the vicinity of corners of the door frame 14.

As shown in FIG. 2, extruded members of the door weather strip 12 has a cavity 32 to enhance the flexibility of the tubular seal part 22 and the base portion 20, and make them lightweight. And a bridge 34 is formed between the tubular seal part 22 and the cavity 32 to connect facing walls of the tubular seal part 22.

As shown in FIG. 4, in molded members of the door weather strip 12, in order to form a cavity in a tubular seal part 36, a core for forming the cavity must be drawn out of a mold by way of a core drawing slit 38 which is provided in a base portion 40. Therefore, considering the core drawing direction, two cavities which are provided in the extruded members (FIG. 2) cannot be formed in the molded members in a vertical direction thereof so that only one cavity is provided. As a result, no bridge is provided in an interior of the tubular seal part of the molded member, and consequently, a cavity becomes large to decrease the rigidity of the tubular seal part 36, thereby lowering the sealing properties.

Where the core drawing slit 38 is provided in the base portion 40, the core drawing slit 38 may open or close upon fitting of the base portion 40 in the retainer 26 (FIG. 2), whereby the retaining force of the base portion 40 against the retainer 26 is reduced, and the base portion 40 may come off the retainer 26. Under these circumstances, after molding, the core drawing slit 38 has been closed by bonding prior to attachment to the retainer (see publication of unexamined Japanese patent application No. 2003-72386, for example).

And, as shown in FIG. 5, where a molded corner member 42 of a door weather strip 44 is attached to a corner of the door frame 14, etc., the molded corner member 42 may come off the corner of the door frame 14, because the molded corner member 42 has a core drawing slit 46, and the corner of the door frame 14 does not include a channel and a retainer such as the retainer 26. Accordingly, an insert 48 composed of a synthetic resin may be embedded in the molded corner member 42. However, in this case, troublesome molding work is required, the rigidity of the molded corner member 42 increases, and troublesome attaching work is also required for the rigid molded corner member 42 (see publication of unexamined Japanese patent application No. 2004-291283, for example).

### SUMMARY OF THE INVENTION

Accordingly, it is an object of the present invention to provide a door weather strip for a motor vehicle, which is difficult to come off a door frame, and is manufactured at a low cost.

According to a first aspect of the present invention, in the door weather strip to be attached to an outer periphery of a door of a motor vehicle for providing a seal between a door opening portion and the door, the door weather strip has extruded members which are formed by extrusion, and molded members which are formed by molding for joining ends of the extruded members to each other, each of the extruded members and the molded members has a base portion for attachment to the outer periphery of the door and a seal portion which is integrally formed with the base portion for contacting and sealing the door opening portion, the extruded members include an upper side member for attachment to an upper side of the outer periphery of the door, and vertical side members for attachment to vertical sides of the outer periphery of the door, each of the vertical side members is composed of an upper vertical part for attachment to an upper part of the vertical side of the outer periphery of the door, and a lower vertical part for attachment to a lower part of the vertical side of the outer periphery of the door, the molded members include corner members for attachment to corners of the outer periphery of the door, and vertical joint members, each joining the upper vertical part and the lower vertical part in about a longitudinal center of the vertical side member, the upper vertical part and the lower vertical part have different cross-sectional configurations from each other, the base portion of the upper vertical part is retained with a retainer formed in the outer periphery of the door, the lower vertical part is retained with clips or double-sided adhesive tapes which are attached to the base portion thereof, the vertical joint member has a core drawing slit in a base portion thereof, which is formed from the position lower than a joint end of the upper vertical part to the position in the vicinity of a joint end of the lower vertical part such that the core drawing slit is not closed by bonding, and the base portion of the vertical joint member, in which the core drawing slit is not formed, is retained with the retainer provided in the outer periphery of the door.

With this arrangement, the door weather strip has extruded members which are formed by extrusion; and molded members which are formed by molding such that ends of the extruded members are joined to each other, each of the extruded members and the molded members has a base portion for attachment to the outer periphery of the door and a seal portion which is integrally formed with the base portion for contacting and sealing the door opening portion. With this arrangement, the extruded members can be speedily formed by extrusion, and then the door weather strip can be formed in conformity with corner configurations of the door by molding. Since the door weather strip is retained along the outer periphery of the door with the base portion thereof, the attaching position of the seal portion can be made stable so that the seal portion can contact the door opening portion securely, thereby ensuring sealing properties.

Since each of the extruded members includes an upper side member for attachment to an upper side of the outer periphery of the door, and vertical side members for attachment to vertical sides of the outer periphery of the door, the upper side and the vertical sides of the outer periphery of the door, which do not curve greatly, can be sealed with the extruded members. In addition, rainwater and noise can be prevented from intruding into a vehicle compartment. Since the vertical side members includes an upper vertical part for attachment to an upper part of the vertical side of the door, and a lower vertical part for attachment to a lower part of the vertical side of the outer periphery of the door, the upper part of the vertical side of the door, which corresponds to the door frame, and the lower part of the vertical side of the outer periphery of the door, which corresponds to the door panel, can be sealed with the upper vertical part and the lower vertical part of the extruded members, which are formed to have different configurations.

The molded members include corner members for attachment to corners of the outer periphery of the door, and vertical joint members, each joining the upper vertical part and the lower vertical part in about a longitudinal center of the vertical side. With this arrangement, the molded corner members conforming to the configurations of the corners of the outer periphery of the door can be attached thereto, and along the vertical side of the periphery of the door, the upper vertical part and the lower vertical part which are separately formed from each other and having different cross-sectional configurations from each other, can be smoothly joined to each other.

The upper vertical part and the lower vertical part have different cross-sectional configurations from each other, the base portion of the upper vertical part is retained with a retainer formed in the outer periphery of the door, and the lower vertical part is retained with clips or double-sided adhesive tapes which are attached to the base portion thereof. With this arrangement, there is no need of providing the retainer in the lower portion of the outer periphery of the door so that the construction of the outer periphery of the door can be made simple.

The vertical joint member has a core drawing slit in the base portion thereof from the position lower than a joint end of the upper vertical part to the position in the vicinity of a joint end of the lower vertical part, and the base portion of the vertical joint member, in which the core drawing slit is not formed, is retained with the retainer provided in the outer periphery of the door. With this arrangement, no slit exists in the base portion of the vertical joint member on the side of the upper vertical part so that the base portion exhibits a high rigidity, and can be securely retained with the retainer.

On the side of the lower vertical part, the core drawing slit is formed to facilitate the drawing of the core. The core drawing slit extends to the vicinity of the joint end of the lower vertical part, and is closed by bonding so that no bonding work is required, thereby facilitating the manufacturing of the vertical joint member, and reducing the manufacturing costs thereof. Since the lower vertical part is attached with clips or double-sided adhesive tapes, the vertical joint member can be securely attached to the outer periphery of the door, though the core drawing slit is formed in the vertical joint member.

According to a second aspect of the present invention, the vertical joint member is formed in the vicinity of a joint of the door frame of the door, and a door panel.

With this arrangement, the door weather strip for attachment to the door frame, and the door weather strip for attachment to the door panel can be smoothly joined to each other even where they have different cross-sectional configurations, the appearance around the joint of the door frame and the door panel is improved, and the base portions of these weather strips can be retained securely.

According to a third aspect of the present invention, one of side end edges of the base portion of the vertical joint member protrudes by a width less than that of the other side end edge of the base portion. With this arrangement, where side walls of the retainer are pressed to have a reduced space therebetween, the side end edge of the base portion, which protrudes by a smaller protruding width, can be retained within an interior of the retainer, or can closely contact the outer periphery of the door.

According to a fourth aspect of the present invention, the side end edge of the base portion of the vertical joint member, which protrudes by a width greater than that of the other side end edge of the base portion, is retained with the retainer. With this arrangement, since the base portion of the vertical joint member is retained with the retainer in the side end edge which protrudes by a width greater than that of the other end edge, the vertical joint member can be stably retained without retaining the other side end edge with the retainer.

According to, a fifth aspect of the present invention, the seal portion has a tubular configuration. With this arrangement, the tubular seal portion can readily deform to contact the door opening portion with a large contacting area, thereby ensuring sealing properties even where a gap between the door and the door opening portion varies.

According to a sixth aspect of the present invention, the lower vertical part defines one end of an integrally and sequentially formed extruded member for attachment to a front-side lower vertical side, a rear-side lower vertical side and a lower side of the outer periphery of the door panel. With this arrangement, the outer periphery of the door panel can be sealed with a single extruded member, thereby facilitating the manufacturing and attaching of the door weather strip.

According to a seventh aspect of the present invention, the molded members and the extruded members are composed of sponge rubbers. With this arrangement, the molded members and the extruded members exhibit flexibility and elasticity so as to be readily attached in conformity with the configuration of the door or the door opening portion of the vehicle body, and securely contact the same, thereby ensuring the sealing properties.

In accordance with the present invention, the vertical joint member has a core drawing slit in a base portion thereof from the position lower than a joint end of the upper vertical part to the position in the vicinity of a joint end of the lower vertical part, and the base portion of the vertical joint member, in which the core drawing slit is not formed, is retained with the retainer provided in the outer periphery of the door. With this arrangement, no slit exists in the base portion of the vertical joint member on the side of the upper vertical part so that the base portion exhibits a high rigidity, and can be securely retained with the retainer. On the side of the lower vertical part, the core drawing slit is formed without being closed by bonding so that no bonding work is required, thereby facilitating the manufacturing of the vertical joint member, and reducing the manufacturing costs thereof. In the vicinity of the joint end, the lower vertical part is attached with clips or double-sided adhesive tapes so that the vertical joint member can be securely attached to the outer periphery of the door, through the core drawing slit is formed in the vertical joint member. Since at least one of side end edges of the base portion of the vertical joint member protrudes by a width less than that of the other side end edge of the base portion, the side end edge of the base portion, which protrudes by a smaller protruding width, can be retained within an interior of the retainer, or can closely contact the outer periphery of the door.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a side view of a motor vehicle;

FIG. 2 is a cross-sectional view of one example of a conventional weather strip, which is attached to an upper side of a door frame of a motor vehicle;

FIG. 3 is a perspective view of a door weather strip;

FIG. 4 is a cross-sectional view of a joint part of a conventional door weather strip;

FIG. 5 is a perspective view of a rear surface of a joint part of another conventional door weather strip;

FIG. 6 is a cross-sectional view of one embodiment of a door weather strip in accordance with the present invention, which is taken on line A-A of FIG. 10;

FIG. 7 is a cross-sectional view of a vertical joint member of one embodiment of a door weather strip in accordance with the present invention, which is taken on line B-B of FIG. 10;

FIG. 8 is a cross-sectional view of a vertical joint member of one embodiment of a door weather strip in accordance with the present invention, which is taken on line C-C of FIG. 10;

FIG. 9 is a cross-sectional view of one embodiment of a door weather strip in accordance with the present invention, which is taken on line D-D of FIG. 10;

FIG. 10 is a perspective view of a vertical joint member, which is seen from a left side thereof, in one embodiment of a door weather strip in accordance with the present invention; and

FIG. 11 is perspective view of a vertical joint member, which is seen from a right side thereof, in one embodiment of a door weather strip in accordance with the present invention.

### DETAILED DESCRIPTION OF THE PREFERRED EMBODIMENTS

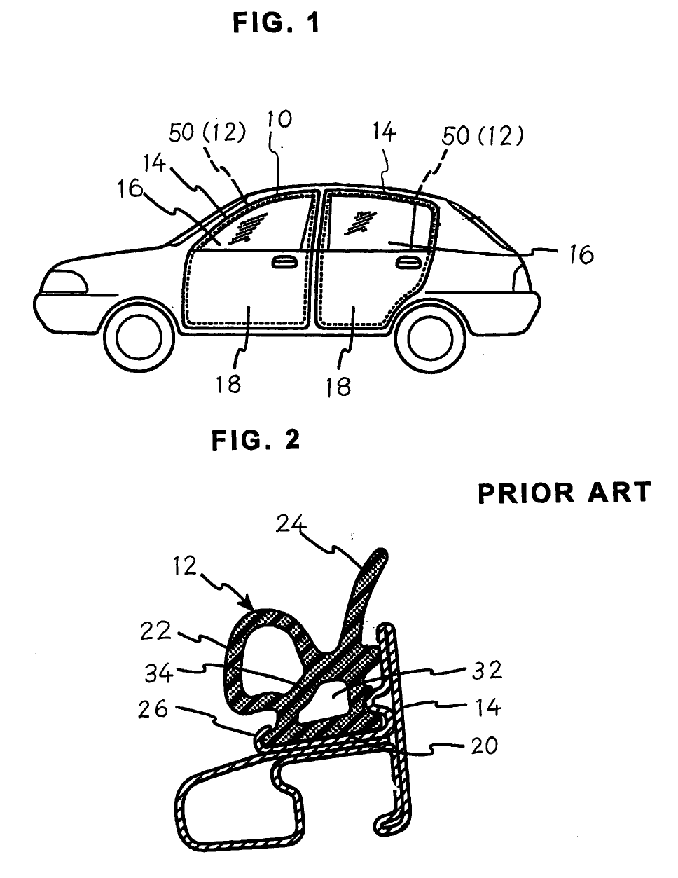

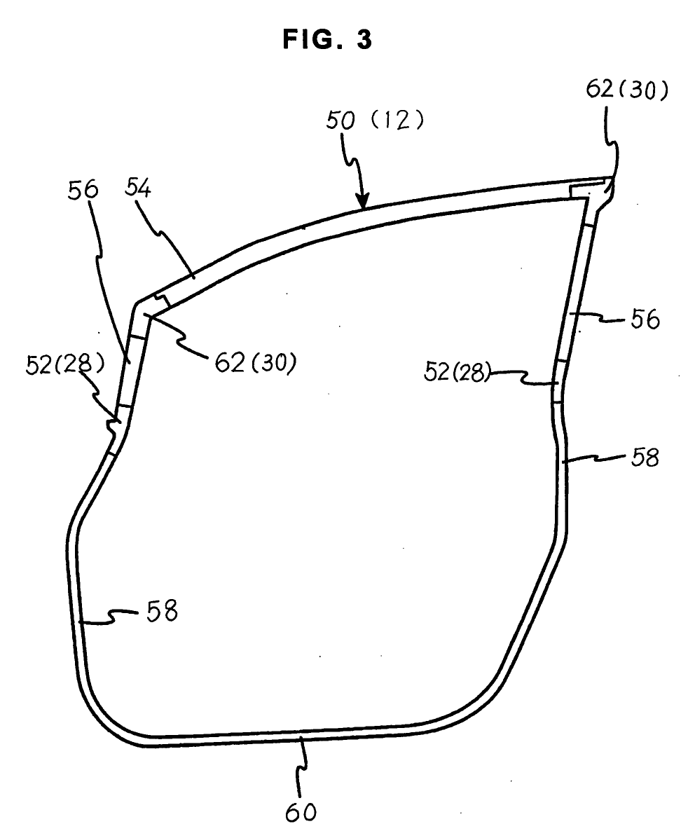

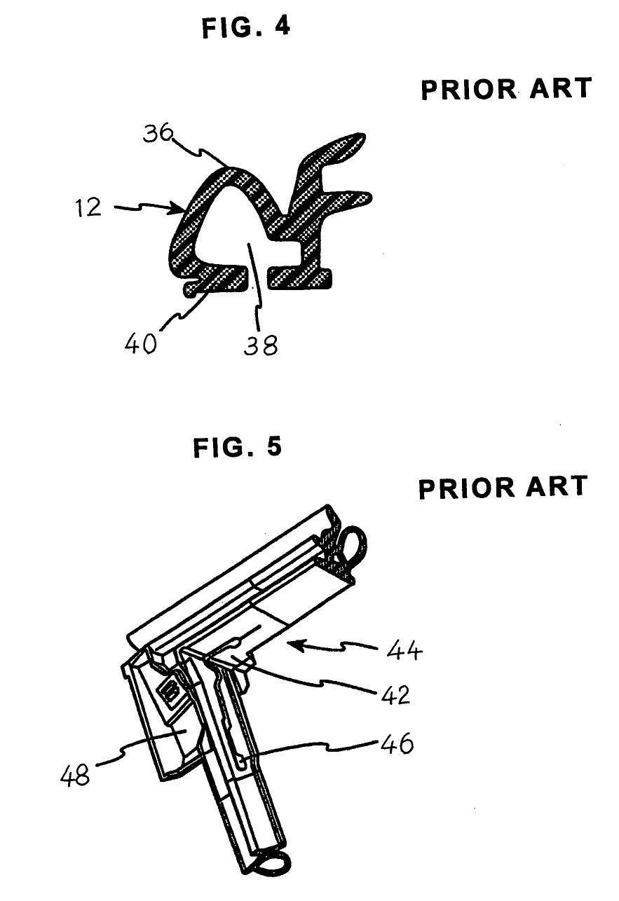

Hereinafter, one embodiment of the present invention will be explained with reference to FIG. 1, FIG. 3 and FIGS. 6 through 11.

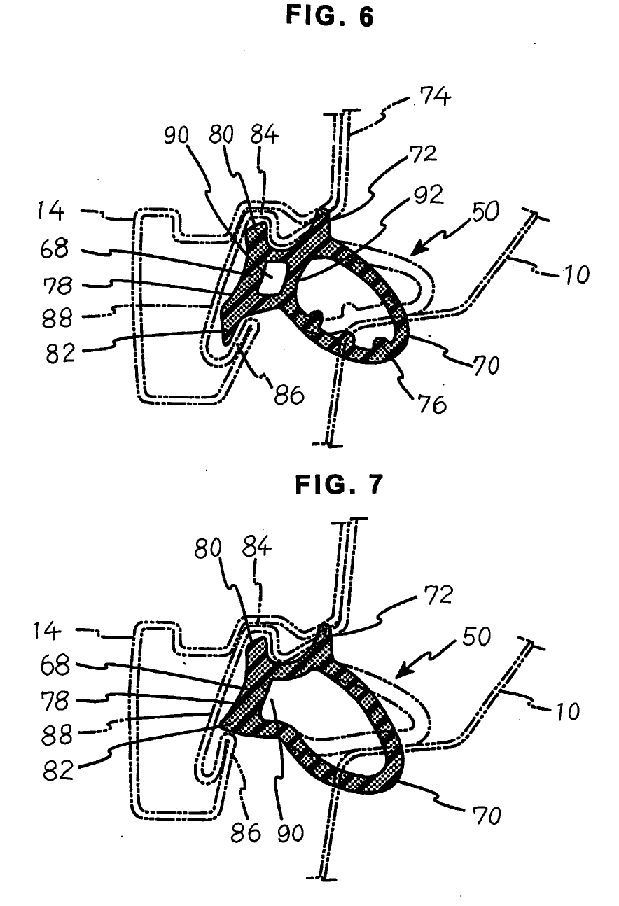

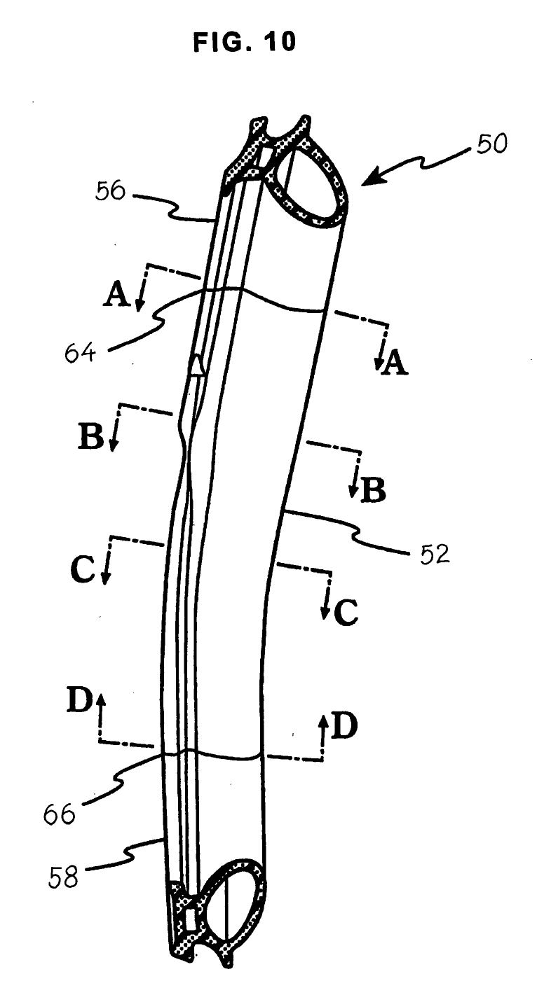

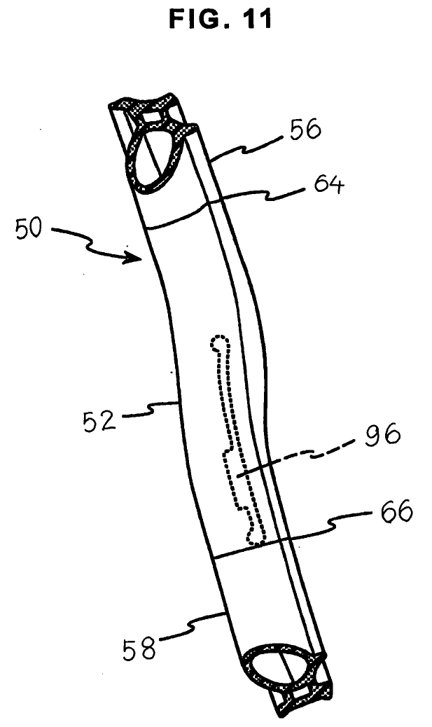

FIG. 1 is a side view of a motor vehicle to which a door weather strip 50 in accordance with the present invention is attached. FIG. 3 is a front view of the door weather strip 50 for attachment to a door panel 18 and a door frame 14. FIG. 10 and FIG. 11 are perspective views of a vertical joint member 52, which are respectively seen from a left side and a right side thereof, and FIG. 6 through FIG. 9 are cross-sectional views which are respectively taken on line A-A through D-D in FIG. 10.

The door weather strip 50 is attached to a periphery of a vehicle door including the door panel 18 and the door frame 14. In the present embodiment, the door weather strip 50 for attachment to a front door will be explained. The present invention can be also applied to a door weather strip for attachment to a rear door in a similar manner. The door weather strip 50 includes extruded members formed by extrusion, and molded members formed by molding for joining ends of adjacent extruded members to each other.

As shown in FIG. 3, the extruded members include an upper side member 54 for attachment to an upper side of the door frame 14, upper vertical members 56 as the upper vertical parts of the vertical side members, which are adapted to be attached to a front vertical side and a rear vertical side of the door frame 14, lower vertical members 58 as the lower vertical parts of the vertical side members, which are adapted to be attached to a front vertical side and a rear vertical side of an outer periphery of the door panel 18, and a lower side member 60 for attachment to a lower side of the door panel 18.

The lower side member 60 can be formed by extrusion sequentially and integrally with the lower vertical members 58. Alternatively, only the lower vertical members 58 can be formed by extrusion without forming the lower side member 60.

The extruded member formed by sequentially and integrally extruding the lower side member 60 and the lower vertical members 58 is bent while being flexed along the outer periphery of the door panel 18. Corners of the door panel 18 have curvatures less than those of corners of the door frame 14, and the cross-sectional configuration of the lower side member 60 is not complicated, as compared with that of the upper side member 54. Therefore, the extruded member including the lower side member 60 is not readily folded or wrinkled so that, in many cases, molded joints are not provided. However, where the curvatures of the corners of the door panel 18 increase, for example, the molded joints may be used.

Molded members are attached to corners and joints provided in the door frame 14, and include corner members 62 for joining the upper side member 54 and the upper vertical members 56 to each other, and the vertical joint members 52 which are provided in the vicinity of joints of the door frame 14 and the door panel 18 for joining the upper vertical members 56 and the lower vertical members 58 to each other. The extruded members and the molded members thus arranged respectively have a base portion and a tubular seal portion, and have different cross-sections which depend on attaching positions thereof.

First, one embodiment of the present invention will be explained based on the door weather strip for attachment to a rear joint of the door frame 14 and the door panel 18 of a front door. The present invention can be similarly applied to a front joint provided in the front door as well as molded members for attachment to a rear door. As shown in FIG. 10 and FIG. 11, the upper vertical member 56 and the vertical joint member 52 define an upper joint line 64 therebetween, and the lower vertical member 58 and the vertical joint member 52 define a lower joint line 66.

The configuration of the upper vertical member 56 in the vicinity of the upper joint line 64 will be explained with reference to FIG. 6. In the vicinity of the upper joint line 64, the cross-section of the vertical joint member 52 is generally identical to that of the upper vertical member 56, and parts of the vertical joint member 52, which are similar to those in the upper vertical member 56, will be given the same reference numerals. The upper vertical member 56 has a base portion 68 for attachment to the door frame 14 and a tubular seal portion 70 which is integrally formed with the base portion 68 for contacting the door opening portion 10.

The tubular seal portion 70 has a seal lip 72 for contacting a door outer panel 74 of the door frame 14. The tubular seal portion 70 seals a gap between the door frame 14 and the door opening portion 10, and the seal lip 72 seals a gap between the door frame 14 and the door weather strip 50. The upper vertical member 56 and the vertical joint member 52 locally have a plurality of ribs 76 in an interior space of the tubular seal portion 70 on both sides of the upper joint line 64. The ribs 76 are formed by molding to enhance the joining strength along the upper joint line 64.

The base portion 68 has a plate-shaped bottom 78 with an arc-shaped cross-member, both side end edges 80 and 82 thereof protrude upwardly and downwardly, and are fitted in an upper side part 84 and a lower side part 86 of a retainer 88 which is formed into an approximately U-shaped cross-member by bending the door outer panel 74 of the door frame 14. Thus, in the vicinity of the upper joint line 64, the plate-shaped bottom 78 of each of the upper vertical member 56 and the vertical joint member 52 has no core drawing slit so that the rigidity thereof is increased, and consequently, the base portion 68 can be held in the retainer 88.

The base portion 68 has a cavity 90 adjacent to the tubular seal portion 70. The cavity 90 servers to increase the flexibility of the base portion 68, and consequently, the door weather strip 50 is readily bent, and the weight thereof is reduced. And a bridge 92 is formed between the tubular seal portion 70 and the cavity 90 to enhance the rigidity of the tubular seal portion 70, thereby preventing abnormal deformations of the tubular seal portion 70 and improving the sealing properties thereof.

Next, the configuration of the vertical joint member 52 of the door weather strip 50 in the position slightly lower than the upper joint line 64, that is the cross-section taken on line B-B of FIG. 10, will be explained with reference to FIG. 7. This position is near a door belt line along which the door frame 14 is jointed to the door panel 18, and in order to join the door frame 14 to the door panel 18, the lower side part 86 of the retainer 88 which is provided in the door frame 14 is made narrow.

The base portion 68 of the vertical joint member 52 is composed of the plate-shaped bottom 78, but no bridge is provided so that the cavity 90 is interconnected with the interior space of the tubular seal portion 70. The upper side edge 80 of the bottom 78 protrudes, similarly to the case shown in FIG. 6, but, the lower side edge 82 thereof does not protrude. The tubular seal portion 70 has a similar configuration to that shown in FIG. 6, but is not provided with ribs in the interior space thereof.

Though the lower side part 86 of the retainer 88 is made narrow, the base portion 68 can be retained in an interior of the retainer 88. Only the upper side edge 80 of the base portion 68 is retained in the upper side part 84 of the retainer 88, but, as shown in FIG. 6, the upper side edge 80 is formed to have a larger width in the area extending slightly downwardly from the upper joint line 64 such that both surfaces of the upper side edge 80 of the base portion 68 are retained with the upper side part 84 of the retainer 88, and in this area, no core drawing slit is formed so as to exhibit a high rigidity, whereby the base portion 68 is prevented from coming off the retainer 88.

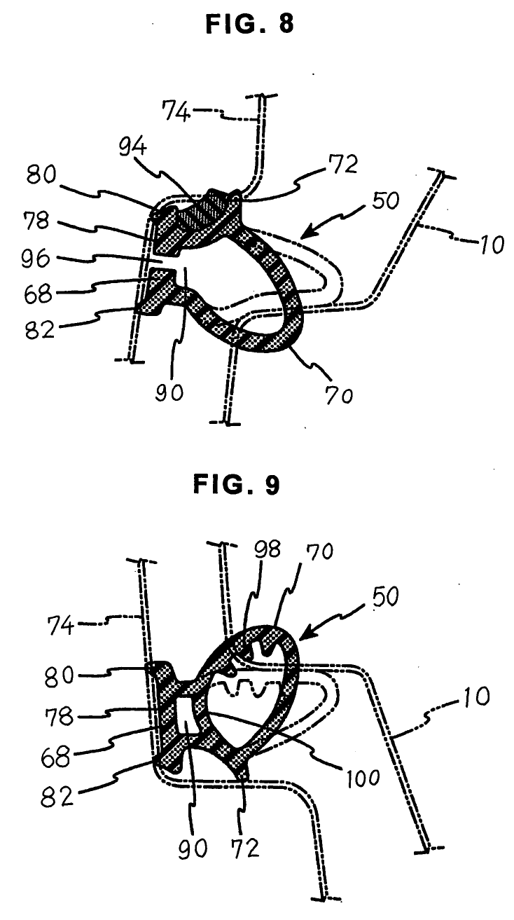

Next, the configuration of about a longitudinal center of the vertical joint member 52, that is the part taken on line C-C of FIG. 10, will be explained with reference to FIG. 8. The bottom 78 of the base portion 68 is formed into a plate-shaped configuration, similarly to the case of FIG. 7. The side edges 80 and 82 thereof protrude upwardly and downwardly such that the upper side edge 80 protrudes to have a large width, as compared with that of the lower side edge 82. The lower side edge 82 can be covered with a garnish (not shown) which is attached to the door panel 18. The cavity 90 is interconnected with the interior space of the tubular seal portion 70 without providing any bridge therebetween. Consequently, the tubular seal portion 70 becomes large, the flexibility of the base portion 68 is enhanced, and the weight of the vertical joint member 52 is reduced.

The bottom 78 of the base portion 68 is held with a bending part which is provided in the door outer panel 74 of the door panel 18 in contact therewith. A caulking sponge 94 may be attached between the bottom 78 of the base portion 68 and the seal lip 72. Where the caulking sponge 94 is attached, the sealing properties between the door weather strip 50 and the door panel 18 can be improved.

A core drawing slit 96 is formed in the bottom 78 of the base portion 68 for drawing a core adapted to form the tubular seal portion 70 upon molding thereof. The core drawing slit 96 is interconnected with the interior of the tubular seal portion 70. As shown in FIG. 11, the core drawing slit 96 extends in the longitudinal direction of the vertical joint member 52 from the position lower than the upper joint line 64 (that is slightly lower than the position taken on line B-B of FIG. 10) to the vicinity of the lower joint line 66.

Consequently, the core adapted to form the tubular seal portion 70 of the vertical joint member 52 can be provided from the upper joint line 64 to the lower joint line 66, and the core can be readily drawn from the core drawing slit 96. Since the core drawing slit 96 is not closed by bonding, no bonding work is needed after molding, thereby facilitating the manufacturing of the vertical joint member 52, and decreasing the manufacturing costs thereof. Since the lower vertical member 58 is attached to the door panel 18 with clips or double-sided adhesive tapes, the base portion 68 of the vertical joint member 52 adjacent to the lower vertical member 58 can be securely attached to the outer periphery of the door panel 18, though the core drawing slit 96 is not bonded.

Next, the configuration of the lower vertical member 58 in the vicinity of the lower joint line 66, that is the position taken on line D-D of FIG. 10, will be explained with reference to FIG. 9. In the vicinity of the lower joint line 66, the cross-sectional configuration of the vertical joint member 52 is similar to that of the lower vertical member 58, and parts of the lower vertical member 58, which are similar to those in the vertical joint member 52, will be given the same reference numerals. As shown, the lower vertical member 58 has the base portion 68 for attachment to the door outer panel 74, and the tubular seal portion 70 which is integrally formed with the base portion 68 for contacting the door opening portion 10.

The tubular seal portion 70 has the seal lip 72 for contacting the door outer panel 74 of the door panel 18. The tubular seal portion 70 seals a gap between the door panel 18 and the door opening portion 10, and the seal lip 72 seals a gap between the door panel 18 and the door weather strip 50. The lower vertical member 58 and the vertical joint member 52 in the vicinity of the lower joint line 68 respectively have a plurality of ribs 98, similarly to the case in the vicinity of the upper joint line 64. The ribs 98 are formed by molding to enhance the joining strength along the lower joint line 66.

The base portion 68 has the plate-shaped bottom 78. Upper and lower side edges 80 and 82 of the bottom 78 of the base portion 68 respectively project inwardly into a bead-shaped configuration. When the door weather strip 50 is attached, the upper and lower side edges 80 and 82 contact the door outer panel 74 of the door panel 18 to improve the sealing properties between the door panel 18 and the base portion 68.

The base portion 68 has the cavity 90 adjacent to the tubular seal portion 70, similarly to the case of the upper vertical member 56. By virtue of the cavity 90, the flexibility of the base portion 68 increases, and consequently, the lower vertical member 58 readily bends along the door frame 14 and the door panel 18, and the Weight thereof is reduced. And a bridge 100 is formed between the tubular seal portion 70 and the cavity 90 to enhance the rigidity of the tubular seal portion 70, thereby preventing abnormal deformations of the tubular seal portion 70 and improving the sealing properties thereof.

Clips or double-sided adhesive tapes are attached to one part or an entire surface of the base portion 68 of the lower vertical member 58, and by fitting the clips in clip holes formed in the door outer panel 74, or bonding the double-sided adhesive tapes to the door outer panel 74, the base portion 68 is attached to the door outer panel 74. Where the double-sided adhesive tapes are used, the base portion 68 can be directly bonded to the outer periphery of the door panel 18, whereby the vehicle body can be made lightweight and the attaching work of the door weather strip can be carried out efficiently.

Next, the method of manufacturing the door weather strip 50 will be explained. The door weather strips for use in front doors, rear doors, etc. of vehicle bodies are manufactured similarly. The manufacturing method of the door weather strip 50 for use in a rear joint of the door frame 14 and the door panel 18 of a front door, that is one example of the door weather strip of the present invention, will be explained.

Extruded members of the door weather strip 50 for attachment to the door frame 14 and the door panel 18 are formed using a synthetic rubber such as an EPDM rubber, etc., and a thermoplastic elastomer such as a polyolefin elastomer, etc. In order to improve the flexibility of the extruded members, it is preferable to use these materials as sponge materials by foaming them.

In case of the synthetic rubber, after extruded, an extruded material is transferred to a vulcanizing chamber, and heated therein with hot wind and high frequency waves, etc. for vulcanization and foaming. In case of the thermoplastic elastomer, it is heated simultaneously with extrusion or sequentially thereafter for foaming, and then cooled for solidification. Then, an obtained material is cut to prepare extruded members such as the upper vertical member 56 and the lower vertical member 58, each having a predetermined length.

The vertical joint member 52 is formed by placing ends of the thus prepared upper vertical member 56 and the lower vertical member 58 in a mold, and injecting a sponge material or a hard material adapted to form the vertical joint member 52 into a cavity of the mold. The cross-sectional configuration of the vertical joint member 52 is approximately identical to that of the upper vertical member 56 and that of the lower vertical member 58. It is preferable to use the same kind of materials as the upper vertical member 56 and the lower vertical member 58.

In case of the synthetic rubber, after it is injected into the mold, the mold is heated for vulcanization and foaming. In this process, since the extruded members and the molded members can be vulcanized and bonded to each other using the identical material or the same kind of materials, they can be fixed integrally with each other. In case of the thermoplastic elastomer, it is injected in a molten phase so that the extruded members and the molded members are welded integrally with each other due to heat and pressure of the molten material.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A door weather strip to be attached to an outer periphery of a door of a motor vehicle for providing a seal between a door opening portion and the door, comprising:
extruded members formed by extrusion; and
molded members formed by molding for joining ends of said extruded members to each other, each of said extruded members and said molded members having a base portion for attachment to the outer periphery of the door and a seal portion which is integrally formed with said base portion for contacting and sealing the door opening portion,
wherein said extruded members include an upper side member for attachment to an upper side of the outer periphery of the door, and vertical side members for attachment to vertical sides of the outer periphery of the door, each of said vertical side members is composed of an upper vertical part for attachment to an upper part of the vertical side of the outer periphery of the door, and a lower vertical part for attachment to a lower part of the vertical side of the outer periphery of the door, said molded members include corner members for attachment to corners of the outer periphery of the door, and vertical joint members, each joining said upper vertical part and said lower vertical part in about a longitudinal center of said vertical side member, said upper vertical part and said lower vertical part have different cross-sectional configurations from each other, said base portion of said upper vertical part is retained with a retainer formed in the outer periphery of the door, said lower vertical part is retained with one of clips and double-sided adhesive tapes which are attached to said base portion thereof, said vertical joint member has a core drawing slit in a base portion thereof, which is formed from the position lower than a joint end of said upper vertical part to the position in the vicinity of a joint end of said lower vertical part such that said core drawing slit is not closed by bonding, and said base portion of said vertical joint member, in which said core drawing slit is not formed, is retained with the retainer provided in the outer periphery of the door.

2. A door weather strip for a motor vehicle, as claimed in claim 1, wherein said vertical joint member is formed in the vicinity of a joint of the door frame of the door, and a door panel.

3. A door weather strip for a motor vehicle, as claimed in claim 1, wherein one of side end edges of said base portion protrudes by a width less than that of the other side end edge of said base portion.

4. A door weather strip for a motor vehicle, as claimed in claim 1, wherein said side end edge of said base portion, which protrudes by a width greater than that of the other side end edge of said base portion, is retained with the retainer.

5. A door weather strip for a motor vehicle, as claimed in claim 1, wherein said seal portion has a tubular configuration.

6. A door weather strip for a motor vehicle, as claimed in claim 1, wherein said lower vertical part defines one end of an integrally and sequentially formed extruded member for attachment to a front-side lower vertical side, a rear-side lower vertical side and a lower side of the outer periphery of the door panel.

7. A door weather strip for a motor vehicle, as claimed in claim 1, wherein said molded members and paid extruded members are composed of sponge rubbers.
